(19) United States
(12) Patent Application Publication
(10) Pub. No.: US 2024/0206518 A1
(43) Pub. Date: Jun. 27, 2024

(54) FLAVORED PARTICLES DELIVERY SYSTEM

(71) Applicant: Firmenich SA, Satigny (CH)

(72) Inventors: Rutger VAN SLEEUWEN, Plainsboro, NJ (US); Nicholas IMPELLIZZERI, Plainsboro, NJ (US); Huda JERRI, Plainsboro, NJ (US)

(21) Appl. No.: 18/291,446

(22) PCT Filed: Aug. 12, 2022
(86) PCT No.: PCT/EP22/72640

§ 371 Date: Jan. 23, 2024

Related U.S. Application Data
(60) Provisional application No. 63/234,004, filed on Aug. 17, 2021.

(30) Foreign Application Priority Data
Sep. 22, 2021 (EP) 21198204.6

(51) Int. Cl. A23P 10/25; A23F 3/40; A23F 5/46; A23L 27/00; A23P 10/47

(52) U.S. Cl. CPC A23P 10/25; A23F 3/405; A23F 5/465; A23L 27/72; A23P 10/47

(57) ABSTRACT

Described herein is a flavored delivery system including different particles and agglomerates of such particles. Also described herein are processes for preparing the system and consumer products containing the system.

### TECHNICAL FIELD

The technical field of the present invention relates to a flavored delivery system comprising different particles and agglomerates of such particles. Processes for preparing said system and consumer products containing said system are also objects of the invention.

### BACKGROUND

There are different ways to impart a flavor to a food product. Among them, one may cite the incorporation of flavored delivery system in food products. By encapsulating flavoring ingredients in particles, the delivery efficiency and active lifetime of the flavoring ingredients can be improved. Particles provide several advantages, such as protecting the flavoring ingredients from physical or chemical reactions with incompatible ingredients in the food product, and from volatilization or evaporation. Particles can be particularly effective in the delivery and preservation of flavors in that flavors can be delivered to and retained within the food product by a particle that releases the flavors upon mastication, cooking or dissolution.

Furthermore, organoleptic feelings associated with a food product are important to many consumers. However, depending on the process for preparing the delivery systems, some constraints can appear regarding the nature of the flavouring ingredients to encapsulate limiting therefore the impact or perception of the organoleptic profile that can be offered to the consumers.

Thus, there is a need in the industry for delivery systems comprising flavouring ingredients, with excellent physical and chemical stability, which release different flavors at the right level for the desired duration while improving the cost-in-use performance, to provide consumers with a delightful and specific organoleptic experience. The present invention satisfies this and other needs of the industry.

### SUMMARY OF THE INVENTION

### Flavored Particles Delivery System

A first object of the present invention is a flavored particles delivery system comprising:
at least a first particle comprising a first carrier and a first flavor oil entrapped within said first carrier; and
at least a second particle comprising a second carrier and a second flavor oil entrapped within said second carrier,
wherein the first flavor oil and the second flavor oil are different and/or the first carrier and the second carrier are different and
wherein at least one first particle is agglomerated with at least one second particle.

### Carrier

The particle defined in the present invention comprises a flavor oil entrapped in a carrier material.

A delivery system is herein understood to protect active ingredients, in particular a flavor oil and/or to control their release.

By carrier or carrier material is herein understood that the material of the carrier is suitable to entrap, encapsulate or hold a certain amount of flavor oil. The delivery system comprises particles that are in a matrix form.

Typically, when the particle is in a matrix form, the carrier material is a matrix material and the particle has to entrap preferably at least 10% by weight of the flavor oil, based on the total weight of the particle.

In a particular embodiment, the carrier or carrier material is a solid carrier material, i.e. an emulsion or solvent is not a carrier or carrier material.

According to an embodiment, the particle is in a matrix form (i.e., oil entrapped within a polymeric matrix, for example a monomeric, oligomeric or polymeric carrier matrix).

In a particular embodiment, the carrier material comprises a monomeric, oligomeric or polymeric carrier material, or mixtures of two or more of these.

An oligomeric carrier is a carrier wherein 2-10 monomeric units are linked by covalent bonds. For example, if the oligomeric carrier is a carbohydrate, the oligomeric carrier may be sucrose, lactose, raffinose, maltose, trehalose, fructo-oligosaccharides or mixtures thereof.

Examples of a monomeric carrier materials are glucose, fructose, mannose, galactose, arabinose, fucose, sorbitol, mannitol or mixtures thereof, for example.

Polymeric carriers have more than 10 monomeric units that are linked by covalent bonds.

According to an embodiment, the first carrier and the second carrier comprises at least one compound chosen in the group consisting of inulin, chicory root fiber, vegetables/fruit/tuber fibers, sucrose, glucose, lactose, levulose, fructose, maltose, ribose, dextrose, isomalt, sorbitol, mannitol, erythritol, xylitol, lactitol, maltitol, pentatol, arabinose, pentose, xylose, galactose, hydrogenated starch hydrolysates, maltodextrin, agar, carrageenan, other gums, polydextrose, synthetic polymers such as polyvinyl alcohol, semi-synthetic polymers such as succinylated starch, cellulose ethers, proteins such as gelatin, and derivatives and mixtures thereof.

According to a particular embodiment of the invention, the first and/or the second carrier comprises maltodextrin or mixtures of maltodextrin with at least one material selected from the group consisting of sucrose, glucose, lactose, levulose, maltose, fructose, isomalt, sorbitol, mannitol, xylitol, lactitol, maltitol and hydrogenated starch hydrolysates.

According to an embodiment, the maltodextrin has a dextrose equivalent (DE) not above twenty (≤20) and more particularly a DE of 18.

According to a particular embodiment, the maltodextrin used in the first carrier and/or the second carrier is a mixture of a maltodextrin having a low DE (typically less than 10) and a maltodextrin having a high DE (typically equals or greater than 10).

According to a particular embodiment, the first carrier comprises modified starch and maltodextrin and the second carrier comprises mono or di-saccharide and maltodextrin.

According to a particular embodiment, the first carrier comprises modified starch and maltodextrin and the second carrier comprises sucrose and maltodextrin.

According to a particular embodiment, the first carrier has a molecular weight Mn comprised between 1250 and 5000 g/mol.

According to a particular embodiment, the second carrier has a molecular weight Mn comprised between 500 and 2000 g/mol.

According to a particular embodiment, the second carrier has a molecular weight Mn greater than 600, preferably greater than 700 g/mol.

According to a particular embodiment, the second carrier has a molecular weight Mn comprised between 600 and 2000 g/mol, preferably between 700 and 2000 g/mol.

Indeed, without intending to be limited to any particular theory, an increase of the molecular weight of the carrier may improve the stability of the physical stability against caking by limiting the moisture migration from one type of particles to another type of particles.

The value Mn can be easily determined by the person skilled in the art, for example by using SEC Multi-Detector System.

As a non-limiting example, the following device and method can be used: the SEC instrument is the Viscotek TDA305 max system (Malvern Instruments, Ltd, UK) with Viscotek Triple Detector Array (TDA) incorporating Refractive Index (RI), Light Scattering (LS), and Viscosity (VS) detectors. A typical method to determine Mn can be the following: the chromatographic system consists of A2000 (CLM3015) and A6000 (CLM3020) (300 mm L×8.0 mm ID, Malvern Instruments Ltd.) put in series after a A7 guard column, with claimed exclusion limits for pullulan of 4 KDa and 2000 KDa respectively. The eluent is 0.1 M sodium nitrate with a flow rate of 0.4 mL/min. The injected volume is 100 μL with sample concentration of around 2 mg/ml. All measurements were conducted at 35° C. Reproducibility of the method is acceptable with standard deviation of 0.06% on retention volume at peak maximum for three consecutive injections.

A person skilled in the art of formulation, can also predict the Mn of any mixture based on knowledge of the Mn of the individual components in the mixture.

The first and/or the second particle can comprise an emulsifier agent. Typical examples include lecithin and citric acid esters of fatty acids, but other suitable emulsifiers are cited in reference texts such as Food emulsifiers and their applications, 1997, edited by G. L. Hasenhuettl and R. W. Hartel.

The first particle can comprise a plasticizer. Among the plasticizer that may be used, one may cite for example water, polyols such as glycerol, propylene glycol and their esters (i.e. Triacetin), and mixtures thereof.

According to an embodiment, the carrier of the first particle and the carrier of the second particle are different. By “different”, it is meant that the carrier of the first particle and the carrier of the second particle differ from the nature and/or the amount of the component(s) contained in the carrier.

### Flavor Oil

By “flavour oil” it is meant here a flavouring ingredient or a mixture of flavouring ingredients, solvents or adjuvants used or the preparation of a flavouring formulation, i.e. a particular mixture of ingredients which is intended to be added to an edible composition (including but not limited to a beverage) or chewable product to impart, improve or modify its organoleptic properties, in particular its flavour and/or taste. The flavor oil is preferably a liquid at about 20° C. but can be solid at about 20° C. for some flavoring ingredients (for example menthol, vanillin . . . ). Flavouring ingredient is understood to define a variety of flavor materials of both natural and synthetic origins, including single compounds or mixtures. Many of these flavouring ingredients are listed in reference texts such as in the book by S. Arctander, Perfume and Flavour Chemicals, 1969, Montclair, N.J., USA, or its more recent versions, or in other works of similar nature such as Fenaroli's Handbook of Flavour Ingredients, 1975, CRC Press or Synthetic Food Adjuncts, 1947, by M. B. Jacobs, van Nostrand Co., Inc. Solvents and adjuvants of current use for the preparation of a flavouring formulation are also well known in the industry. These substances are well known to the person skilled in the art of flavoring and/or aromatizing foods and consumer products. The flavoring ingredient may be a taste modifier or a taste compound.

Examples of taste compounds are salt, inorganic salts, organic acids, sugars, amino acids and their salts, ribonucleotides, and sources thereof.

A “taste modifier” is understood as an active ingredient that operates on a consumer's taste receptors, or provides a sensory characteristic related to mouthfeel (such as body, roundness, or mouth-coating) to a product being consumed. Non-limiting examples of taste modifiers include active ingredients that enhance, modify or impart saltiness, fattiness, umami, kokumi, heat sensation or cooling sensation, sweetness, acidity, tingling, bitterness or sourness.

According to an embodiment, the first and/or the second flavour oil comprise an active ingredient suitable for use in food and beverages wherein the ingredient is susceptible to oxidation and/or acid degradation. The below listed ingredients may be used in the system to be protected against oxidation and/or degradation or the listed ingredients can also be used as a co-ingredient in combination with an active ingredient susceptible to oxidation and/or acid degradation.

Particular ingredients provided herein are flavors or flavor compositions particularly those flavors characterized by a log P value of 2 or more.

Further provided herein are flavors that are derived from or based on fruits where citric acid is the predominant, naturally-occurring acid include but are not limited to, for example, citrus fruits (e.g., lemon, lime), limonene, strawberry, orange, and pineapple. In one embodiment, the flavor is lemon, lime or orange juice extracted directly from the fruit. Further embodiments of the flavor comprise the juice or liquid extracted from oranges, lemons, grapefruits, limes, citrons, clementines, mandarins, tangerines, and any other citrus fruit, or variation or hybrid thereof. In a particular embodiment, the flavor comprises a liquid extracted or distilled from oranges, lemons, grapefruits, limes, citrons, clementines, mandarins, tangerines, any other citrus fruit or variation or hybrid thereof, pomegranates, kiwifruits, watermelons, apples, bananas, blueberries, melons, ginger, bell peppers, cucumbers, passion fruits, mangos, pears, tomatoes, and strawberries.

In a further embodiment, the flavor is lemon or lime. In a further embodiment the flavor comprises citral.

Other active ingredients contemplated for use herein are those selected from the group consisting of 4-amino-5-(3-(isopropylamino)-2,2-dimethyl-3-oxopropoxy)-2-methylquinoline-3-carboxylic acid; 4-amino-5,6-dimethylthieno[2,3-d]pyrimidin-2(1H)-one; (S)-1-(3-(((4-amino-2,2-dioxido-1H-benzo[c][1,2,6]thiadiazin-5-yl)oxy)methyl)piperidin-1-yl)-3-methylbutan-1-one; and 3-[(4-amino-2,2-dioxido-1H-2,1,3-benzothiadiazin-5-yl)oxy]-2,2-dimethyl-N-propylpropanamide.

Further ingredients contemplated for use herein comprise those selected that are sweetness imparting compounds. In a particular embodiment the sweetness imparting compound is selected from the group consisting of stevia extracts, glycosylated derivatives of stevia extracts (for example, but not limited to, the transglucosylated sweet glycoside mixture of Stevia), sugars (for example, but not limited to, sucrose, glucose, fructose, high fructose corn syrup and corn syrup), sucralose, D-tryptophan, NHDC, polyols (sugar alcohols for example but not limited to sorbitol, xylitol, mannitol, xylose, Monk fruit extract, erythritol, arabinose, rhamnose and lactose), stevioside, Rebaudioside A, thaumatin, mogrosides (for example but not limited to those present in Luo Han Guo extract), monellin, neotame, aspartame, alitame, potassium acesulfame, saccharine, monoammonium glycyrrhizinate, calcium cyclamate, sodium cyclamate, sodium saccharin, potassium saccharin, ammonium saccharin, and calcium saccharin.

According to another embodiment, the first and/or the second flavour oil comprise an active ingredient suitable for use in food and beverages wherein the ingredient is susceptible to volatilization, conversion and/or degradation at high temperatures, typically greater than 70° C.

According to an embodiment, the first flavor oil comprises heat susceptible flavoring ingredients and the second flavor oil comprises oxidation susceptible flavoring ingredients.

Ingredient susceptible to high temperature may be chosen in the group consisting of limonene and other monoterpenes, aldehydes, alcohols, sulfur (such as thiols, thioaldehydes, mercaptoterpenes, thioterpenes), ketones, carbonyls and mixtures thereof.

According to a particular embodiment, the first flavor oil comprises flavoring ingredients susceptible to volatilization, conversion and/or degradation at high temperatures, typically greater than 70° C. and the second flavor oil comprises flavoring ingredients susceptible to oxidation and/or acid degradation.

In the first flavor oil, the amount of flavoring ingredients susceptible to high temperature are preferably used in an amount comprised between 1 to 80%, particularly between 1 to 50% based on the total weight of the first flavor oil.

In the second flavor oil, the amount of flavoring ingredients susceptible to oxidation and/or acid degradation are preferably used in an amount comprised between 1 to 80%, particularly between 1 to 50% based on the total weight of the second flavor oil.

According to an embodiment, the first flavor oil comprises flavoring ingredients chosen in the group consisting of acid, alcohol, aldehyde, ester, furan, furanone-ketone, ketone and mixtures thereof.

According to an embodiment, the second flavor oil comprises flavoring ingredients chosen in the group consisting of acid, alcohol, aldehyde, ketone, lactone, phenol, pyrazine and mixtures thereof.

According to an embodiment,
the first flavor oil comprises at least 10% of flavoring ingredients having a molecular weight less than 100 Dalton and/or a vapor pressure higher than 10 mmHg and/or a boiling point (at the standard pressure) less than 100° C., and/or
the second flavor oil comprises at least 25% of flavoring ingredients having a molecular weight greater than 100 Dalton and/or a vapor pressure less than 10 mm Hg and/or a boiling point (at the standard pressure) higher than 100° C.

According to an embodiment, the first flavor oil comprises at least 25% of flavoring ingredients having a molecular weight less than 100 Dalton and/or a vapor pressure higher than 10 mmHg and/or a boiling point (at the standard pressure) less than 100° C.

According to an embodiment, the first flavor oil comprises at least 40% of flavoring ingredients having a molecular weight less than 100 Dalton and/or a vapor pressure higher than 10 mmHg and/or a boiling point (at the standard pressure) less than 100° C.

According to an embodiment, the second flavor oil comprises at least 50% of flavoring ingredients having a molecular weight greater than 100 Dalton and/or a vapor pressure less than 10 mm Hg and/or a boiling point (at the standard pressure) higher than 100° C.

According to an embodiment, the second flavor oil comprises at least 75% of flavoring ingredients having a molecular weight greater than 100 Dalton and/or a vapor pressure less than 10 mm Hg and/or a boiling point (at the standard pressure) higher than 100° C.

The boiling point of many flavors ingredients can be obtained from different chemistry handbooks and databases, such as the Beilstein Handbook, Lange's Handbook of Chemistry, and the CRC Handbook of Chemistry and Physics. The boiling point is given at the standard pressure (760 mm Hg).

Vapor pressure of flavoring components can also be determined easily based on the existing literature (for example the CRC Handbook of Chemistry and Physics) or calculated with dedicated Software.

The first and the second particles can have different particle size.

Extruded particles have typically a size comprised between 0.1 and 5000 microns, preferably between 400 and 800 microns, whereas spray-dried particles have typically a size comprised between 50 and 500 microns, preferably between 50 to 250 microns.

In a particular embodiment, the average size of the particles is typically between 0.1 and 1000 microns, preferably between 400 and 800 microns.

According to a particular embodiment, the weight ratio between the first particle and the second particle is comprised between 10:90 and 90:10, preferably between 20:80 and 80:20, more preferably 50:50 and 20:80 or 80:20, respectively.

### Agglomeration of Particles

In the flavored particles delivery system of the invention, at least one first particle is agglomerated with at least one second particle.

Agglomeration of first and second particles is herein understood as a single first and single second particles that are attached or connected to each other, respectively.

According to an embodiment, the agglomeration may be due to physical adhesion and/or chemical bonding between the particles. Physical adhesion may herein be understood to be adhesion resulting from non-covalent interactions between the particles. Non-covalent interactions between particles resulting in adhesion are known in the art, an example for a non-covalent interaction may be physisorption by Van-der-Waals forces. Chemical bonding between particles may herein be understood to be realized by covalent bonds and/or ionic bonds.

According to a preferred embodiment, the single first and second particles are connected by bridging, preferably by means of amorphous or crystalline bridges. According to a preferred embodiment, the single first and second particles are connected by bridging between the particles formed by dissolving the surface layer of the particles with a suitable liquid, preferably water, and subsequent evaporation of this solvent.

According to another embodiment, this may be realized by a coating that covers the single first and single second particles of an agglomerate. Such a coating may be realized by coating the particles with at least one compound chosen in the group consisting of inulin, chicory root fiber, vegetables/fruit/tuber fibers, sucrose, glucose, lactose, levulose, fructose, maltose, ribose, dextrose, isomalt, sorbitol, mannitol, xylitol, lactitol, maltitol, erythritol, pentatol, arabinose, pentose, xylose, galactose, hydrogenated starch hydrolysates, maltodextrin, agar, carrageenan, other gums, corn syrup, polydextrose, synthetic polymers such as polyvinyl alcohol, semi-synthetic polymers such as succinylated starch, cellulose ethers, proteins such as gelatin, and derivatives and mixtures thereof.

According to an embodiment, the fraction of agglomerated first particles and second particles is more than 80 wt. %, more preferably more than 85 wt. %, even more preferably more than 90 wt. %, most preferably more than 95 wt. %, based on the total weight of the flavored particles delivery system.

According to an embodiment, the powder content of the flavored particles delivery system is not more than 20 wt. %, more preferably not more than 15 wt. %, even more preferably not more than 10 wt. %, most preferably not more than 5 wt. %, based on the total weight of the flavored particles delivery system.

The powder content of the flavored particles delivery system is herein understood as the remaining fraction of non-agglomerated powdered first and second particles.

According to an embodiment, the flavored particles delivery system of the invention was made by addition of 0.1 to 15 wt. % water, preferably of 0.2 to 5 wt. %, more preferably of 0.3 to 3 wt. %, even more preferably of 0.4 to 2 wt. %, and most preferably of 0.5 to 1 wt. %, based on the total weight of the flavored particles delivery system.

According to an embodiment, the agglomerated first and second particles have a moisture content of 15% or less, preferably of 10% or less, more preferably of 7% or less, even more preferably 5% or less, more preferably of 3% or less. The moisture content can be measured by Karl Fischer titration.

According to an embodiment, the agglomerated first particles and second particles form a granular material. According to a preferred embodiment, the granular material is free flowing. A free-flowing granular material is herein understood to be a material wherein the agglomerates according to the invention do not further stick together.

According to an embodiment, the agglomerates of the first particles and second particles have a weight of 1 to 100 mg, preferably of 1 to 50 mg, such as 5 to 50 mg, more preferably of 1 to 20 mg, even more preferably of 1 to 10 mg.

According to an embodiment, the agglomerates of the first particles and second particles have a diameter of 0.1 to 10 mm, preferably of 0.2 to 8 mm, more preferably of 0.3 to 5 mm. According to an embodiment, the agglomerates of the first particles and second particles have an average diameter of 0.1 to 10 mm, preferably of 0.2 to 8 mm, more preferably of 0.3 to 5 mm. The diameter and average diameter of the agglomerates can be measured by microscopy (e.g., a stereomicroscope with scale).

According to an embodiment, the agglomerates of the first particles and second particles have a weight fraction of first particles of 10 to 70 wt. %, preferably of 20 to 60 wt. %, more preferably of 30 to 50 wt. %, based on the total weight of the agglomerated first particles and second particles.

According to an embodiment, the agglomerates of the first particles and second particles have a weight fraction of second particles of 30 to 90 wt. %, preferably of 40 to 80 wt. %, more preferably of 50 to 70 wt. %, based on the total weight of the agglomerated first particles and second particles.

According to an embodiment, the agglomerates of the first particles and second particles have a weight ratio of the first particles to the second particles of 90:10 to 10:90, preferably 70:30 to 30:70, more preferably 60:40 to 40:60.

According to an embodiment, the agglomerates also comprise further additives such as nutraceuticals, for example amino acids, herbs and other botanicals, enzymes and mixtures thereof; vitamins, for example vitamin A (such as retinol, retinals and carotenoids), vitamin B1 (Thiamin), vitamin B2 (riboflavin), vitamin B3 (such as niacin, niacinamide, nicotinamide roboside), vitamin B5 (pantothenic acid), vitamin B6 (such as pyridixine, pyridoxamine, pyridoxal), vitamin B7 (Biotin), Vitamin B9 (such as folates or folic acid), vitamin B12 (such as cyanocobalamin, hydroxocobalamin, methylcobalamin or adensoylcobalamin), vitamin C (ascorbic acid), vitamin D (such as cholecalciferol, ergocalciferol), vitamin E (such as tocopherols or tocotrienols), vitamin K (such as phylloquinone or menaquinones) or mixtures thereof, preferably vitamin C (ascorbic acid); minerals, for example a source of calcium, fluoride, iodine, iron, magnesium, phosphours, potassium, selenium sodium or zinc or any mixture thereof, preferably sodium chloride, magnesium chloride, or mixtures thereof; and mixtures thereof.

According to an embodiment, the agglomerates also comprise additional microcapsules comprising a flavorant.

Additional microcapsules that can be used in the present invention can be spray-dried microcapsules, dried microcapsules as described in WO 2017/134179, core-shell microcapsules comprising a flavorant in the core, and mixtures thereof.

Specific Microcapsules that can be used in the present invention are disclosed for example in WO 2017/134179 and can be prepared according to a process disclosed therein; the disclosure of which regarding the microcapsules and the process for preparation are herein incorporated by reference.

### Process for Preparing Particles

Processes for preparing particles as defined in the present invention are well-known in the art. One may cite as non-limiting examples, extrusion (hot extrusion or twin-screw extrusion), spray-drying, granulation.

### Twin-Screw Extrusion

According to another embodiment, the first and/or the second particles is prepared by twin-screw extrusion for example according to the methods disclosed in International Patent Application Publication No. WO2016/102426 A1.
The first and/or the second particles may be prepared by a twin-screw extrusion process comprising the steps of:
a) preparing a mixture of a continuous phase carrier containing a flavor oil finely divided therein and having a low water content such that said mixture has a glass transition temperature Tg above room temperature;
b) heating said mixture within a screw extruder to a temperature comprised between 90 and 130° ° C. to form a molten mass;
c) extruding the molten mass through a die;
d) chopping the molten mass as it exits the die to provide a product having a glass transition temperature Tg which is essentially the same as that of the mixture.
   The first and/or the second particles may be prepared by a twin-screw extrusion process comprising the steps of:
a) mixing at least a carrier material and a plasticizer, preferably water, to form a mixture;
b) heating the mixture at a temperature sufficient to form a molten mass;
c) extruding the molten mass through a die to form an extrudate;
d) cutting or crushing the extrudate to form an extruded particle,
   wherein a flavor is added to the mixture in step a) and/or in the molten mass in step b).

The glass transition temperature of the flavour and carrier mixture depends on the amount of plasticizer added to the initial mixture.

According to an embodiment, the glass transition temperature of the particle is substantially the same as the glass transition temperature of the mixture. This is attained by ensuring low or no loss of water.

According to this particular embodiment, a small amount of plasticizer, is added to the mixture to guarantee that the glass transition temperature (T_{g}) of the resulting melt corresponds to and is substantially the same as that of the desired T_{g} value of the final product. In other words, contrary to other methods such as wet-granulation, the glass transition temperature of the mixture before extrusion has already the value required for the final product, which temperature is above room temperature and preferably above 40° C. so that the product can be stored at ambient temperature in the form of free-flowing particles. Consequently, this embodiment of the invention can dispense with the additional drying step following the extrusion, intended to remove water in order to increase T_{g} to an acceptable value.

The proportions in which plasticizer is employed in the present invention therefore vary in a wide range of values which the skilled person is capable of adapting and choosing as a function of the nature of the carrier and the required T_{g} of the final product.

According to an embodiment, the plasticizer content is such that said mixture has a glass transition temperature T_{g} above room temperature.

The plasticizer is preferably water, however polyols such as glycerol, propylene glycol and their esters (i.e. Triacetin) could be used as well. Small polar molecules can be used to lower the T_{g}, one may cite also organic acids (citric, malic . . . ), amino acids, mono and disaccharides (glucose, maltose fructose, sucrose . . . ) and mixtures thereof.

According to a particular embodiment, a mixture of water and polyol such as propylene glycol is used as a plasticizer.

According to a particular embodiment, a polyol such as propylene glycol is used as a plasticizer.

Indeed, it has been shown that the substitution or the partial substitution of water by a polyol such as propylene glycol may improve the physical stability of the delivery system against caking. Indeed, the introduction of such plasticizer can reduce the water activity of the carrier of the first particle and therefore limit or eliminate water migration towards the other type of particles (second particles). Typically, a polyol may be introduced in an amount comprised between 10 and 90%, preferably between 25 and 75%, more preferably between 40 and 60% by weight based on the total weight of the plasticizer.

Typically, the plasticizer is used in an amount comprised between 0.5 and 10%, preferably between 0.5 and 5%, based on the total weight of the mixture of step a).

The extruded particles may be formed at the die face of the extruder while still hot using for example cutting process.

In one embodiment the extruded particles have a size of about 0.5 to 5 mm

The mixture is thus extruded in an extruder assembly which maintains the temperature of the mixture at a predetermined temperature which is comprised typically between 90 and 130° C. This temperature is adapted to the system of the invention: first of all, it has to be above the glass transition temperature of the carrier in order to keep the mixture in the form of a molten mass. Pressure is also applied and adjusted to a value appropriate to maintain homogeneity of the melt. Typically, pressure values of up to 100 bar (107 Pa) can be used depending on the size of the equipment (for example one may need to increase the pressure to 200 bar for larger scale extruders).

In this particular embodiment, as the mixture comes to the die part of the extruder, the temperature is still above the glass transition temperature of the carrier. The extruder is equipped with a cutter-knife and the mixture is thus cut at the temperature of the melt. Once cooled to ambient temperature by the surrounding air, the already cut glassy material does not need to be shaped or dried in a spheroniser, fluid-bed dryer or other device, unlike what is the case with other processes where the molten matrix is cooled prior to the cutting. In a particular embodiment the surrounding air comprises chilled air.

The glass transition temperature of the flavour oil/matrix depends on the amount of plasticizer added to the initial mixture. In fact, it is well known in the art that the T_{g} decreases when the proportion of water increases. In the latter embodiment of the invention, the proportion of plasticizer added to the mixture will be low, i.e. such that the glass transition temperature of the resulting mixture is substantially equal to the glass transition temperature desired for the final flavour delivery system, i.e. the extruded product.

Now, as mentioned above, a requirement for the resulting encapsulated compound or composition is to present a glass transition temperature T_{g} significantly above the temperature at which it will be stored and subsequently used. The critical temperature (T_{g}) must thus be at least above room temperature and preferably above 40° C. The proportions in which water is employed in the present invention therefore vary in a wide range of values which the skilled person is capable of adapting and choosing as a function of the carbohydrate glass used in the matrix and the required T_{g} of the final product.

As cited before the extruding step of this process requires an extruding apparatus. A commercially acceptable extruding apparatus is that under the trade name designation Clextral BC 21 twin-screw extruder equipped with a cutter-knife allowing to chop the melt at the die exit, when it is still plastic. The product which is cut is thus still at a temperature which is above the glass transition temperature of the matrix.

Extruding apparatuses are not limited to the twin screw variety and may also include, for example, single screw, ram, or other similar extrusion methods.

During the extrusion process, the mixture is forced through a die having an orifice with a predetermined diameter which ranges from about 0.250 to 10 mm, more particularly from about 0.5 up to about 2.0 mm and more particularly from 0.7 to 2.0 mm. However, much larger diameters for the die are also possible.

The length of the pieces is regulated by controlling the stroke rate of the specific cutting apparatus.

The severed pieces are subsequently cooled to ambient temperature by the surrounding air. No drying or further treatment is needed. The resulting granules present a size uniformity and this size uniformity of the resulting capsules allows an improved control of flavour release.

According to this particular embodiment of the invention, where the granulation is carried out as the melt exits the die, there are thus obtained solid flavor delivery systems of substantially uniform granulometry.

In another embodiment, a lubricant is provided herein. While not wishing to be bound to any theory it is believed that the lubricant reduces shear and expansion of the molten mass at the exit die. In some embodiments, the lubricant may comprise a medium chain triglyceride (MCT). In another embodiment, the lubricant comprises a micellar surfactant like lecithin or a fatty acid ester (e.g., citric, tartaric, acetic), DATEM, CITREM or mixtures of the above. In a particular embodiment, the lubricant may be provided in an amount, by weight, up to about 5%, particularly about 0.2 up to about 5%, more particularly from about 0.8% up to about 2% and even more particularly from about 1 to 2% of the total weight of the particle. In the embodiment the lubricant is provided in an amount of 2% of the total weight of the particle. In another embodiment the lubricant is provided in an amount of 1% of the total weight of the particle.

### Hot Melt Extrusion

According to another embodiment, the first and/or the second particles is prepared by hot melt extrusion for example according to the methods disclosed in International Patent Application Publication No. WO2004/082393.

The first and/or the second particles may be prepared by hot melt extrusion process comprising the following steps:
a) preparing an aqueous solution of at least one carrier to form a syrup;
b) heating the syrup to form a concentrated solution or melt;
c) uniformly dispersing an active flavor ingredient or composition throughout the melt to form a melt-active mixture;
d) cooling the melt-active mixture to a temperature to which the mixture is in a molten state;
e) extruding the molten mixture into a cool organic solvent wherein the extruded molten mass is broken up into particles; and
f) drying the particles:

According to a particular embodiment, steps a) to f) are carried out continuously and steps b) and d) are carried out by passing the syrup in step b), respectively the melt-active mixture in step d), onto the surface of a heat-exchanger.

According to an embodiment, step b) is carried out on a swept surface heat exchanger.

According to an embodiment, step d) is carried out on a scraped surface heat exchanger.

According to an embodiment, the syrup is heated in step b) to a temperature comprised between 105 and 150° C.

According to an embodiment, the mean residence time of the syrup in the heat exchanger in step b) is comprised between 1 and 10 min.

According to an embodiment, the aqueous solution of step a) contains from 12 to 40% by weight of water relative to the total weight of the solution.

According to an embodiment, the aqueous solution of step a) is prepared by means of conveying the starting materials from a dry solid weight tank to a mixing tank and a heating tank, and then pumping from the heating tank through a multitube heat exchanger and back to the hot tank in a loop.

According to an embodiment, the melt at the end of step b) has a moisture content comprised between 2 and 11% by weight.

According to an embodiment, step c) is carried out by means of a high shear homogenizer wherein the residence time of the mixture is of less than 1 min.

According to an embodiment, the melt-active mixture is cooled to a temperature comprised between 102 and 135° C.

According to an embodiment, at least 90% by weight of the flavor ingredient or composition dispersed through the melt in step c), is effectively encapsulated in the prepared particulate composition.

According to an embodiment, the extrusion step is carried out at a pressure comprised between 1×10⁵ Pa and 3×10⁵ Pa.

### Spray-Drying Process

According to an embodiment, the first and/or the second particles is prepared by spray drying for example according to the methods disclosed in U.S. Patent Application Publication No. 2015/0374018 A1.

The first and/or the second particles may be prepared by a process comprising the steps of:
(i) preparing an emulsion comprising:
   water,
   a carrier,
   a flavor oil,
   optionally, an emulsifier
(ii) drying the emulsion obtained in step i) so as to obtain a powdered composition.

The emulsion can be formed using any known emulsifying method, such as high shear mixing, sonication or homogenization. Such emulsifying methods are well known to the person skilled in the art.

According to an embodiment, the emulsion has a viscosity comprised between 50 mPa·s and 500 mPa's at 65° C. with shear rate of 100 s⁻¹ The flow viscosity was measured using a TA Instruments AR2000 rheometer (New Castle, DE, USA) with concentric cylinder geometry.

In a preferred aspect of the invention, the amount of water in the emulsion is comprised between 40 and 60% by weight, relative to the total weight of the emulsion.

According to an embodiment, the amount of the carrier in the emulsion is comprised between 40 and 60% by weight, relative to the total weight of the emulsion.

According to an embodiment, the amount of active ingredient in the emulsion is comprised between 10 and 30% by weight, relative to the total weight of the emulsion.

The emulsion may also contain optional ingredients. It may in particular further contain an effective amount of a fireproofing or explosion suppression agent. The type and concentration of such agents in spray-drying emulsions is known to the person skilled in the art. One can cite as non-limiting examples of such fireproofing or explosion suppression agents inorganic salts, C₁-C₁₂ carboxylic acids, salts of C₁-C₁₂ carboxylic acids and mixtures thereof. Preferred explosion suppression agents are, salicylic acid, acetic acid, propionic acid, butyric acid, isobutyric acid, valeric acid, caproic acid, citric acid, succinic acid, hydroxysuccinic acid, maleic acid, fumaric acid, oxylic acid, glyoxylic acid, adipic acid, lactic acid, tartaric acid, ascorbic acid, the potassium, calcium and/or sodium salts of any of the afore-mentioned acids, and mixtures of any of these.

Other optional ingredients include antioxidants, preservatives, colorants and dyes.

The droplet size d(v,0.9) of the emulsion is preferably comprised between 0.5 and 15 μm, more preferably between 0.5 and 10 μm.

According to an embodiment, in step ii), the emulsion is spray-dried so as to obtain a powdered composition.

When spray-drying is used, the emulsion is first subjected to a spraying step during which the emulsion is dispersed in the form of drops into a spraying tower. Any device capable of dispersing the emulsion in the form of drops can be used to carry out such dispersion. For instance, the emulsion can be guided through a spraying nozzle or through a centrifugal wheel disk. Vibrated orifices may also be used.

In one aspect of the invention the emulsion is dispersed in the form of drops into a cloud of powdering agent present in the dry tower. Such type of process is for example described in details in WO2007/054853 or in WO2007/135583.

For a specific formulation, the size of the particles is influenced by the size of the drops that are dispersed into the tower. When a spraying nozzle is used for dispersing the drops, the size of such drops can be controlled by the flow rate of an atomising gas through the nozzle, for example. In the case where a centrifugal wheel disk is used for dispersal, the main factor for adjusting droplet size is the centrifugal force with which the drops are dispersed from the disk into the tower. The centrifugal force, in turn, depends on the speed of rotation and the diameter of the disk. The feed flow rate of the emulsion, its surface tension and its viscosity are also parameters controlling the final drop size and size distribution. By adjusting these parameters, the skilled person can control the size of the drops of the emulsion to be dispersed in the tower.

Once sprayed in the chamber, the droplets can be dried using any technique known in the art. These methods are perfectly documented in the patent and non-patent literature in the art of spray-drying. For example, Spray-Drying Handbook, 3^{rd} ed., K. Masters; John Wiley (1979), describes a wide variety of spray-drying methods.

The process of the present invention may be performed in any conventional spraying tower. A conventional multi-stage drying apparatus is for example appropriate for conducting the steps of this process. It may comprise a spraying tower, and, at the bottom of the tower, a fluidised bed intercepting partially dried particles after falling through the tower.

The amount of flavour lost during the spray drying step is preferably below 15%, more preferably below 10%, most preferably below 5%, these percentages being defined by weight, relative to the theoretical amount that would be present in the particles if there was absolutely no flavour lost during the spray-drying step.

Depending on the nature of the encapsulated flavour, one method will be preferred compared to another one. Preferably, when the particles contained a heat sensitive flavour oil, a process which does not require high temperature or wherein high temperature is required only during a limited period of time will be used to prepare particles.

According to a particular embodiment, the first particle and the second particle are obtained by different processes.

According to a particular embodiment, the first particle is obtained by twin-screw extrusion and the second particle is obtained by hot melt extrusion.

### Process of Preparing Agglomerated Particles

According to the invention, a flavored particles delivery system is prepared by a process comprising the steps of:
a. Providing at least a first particle and at least a second particle;
b. Mixing the first particle and the second particle to form a mixture;
c. Bringing the mixture in contact with a liquid to form a wet mixture, wherein the amount of liquid is suitable for wet granulation;
d. Conducting wet granulation of the wet mixture.

According to an embodiment, the process of the invention is a wet granulation process.

According to one embodiment, the flavored particles delivery system according to the invention is prepared by wet granulation, preferably by the process of preparing agglomerated particles as herein-described.

According to an embodiment, in step a. of the process the first particle and the second particle are provided in a weight fraction of first particle of 10 to 70 wt. %, preferably of 20 to 60 wt. %, more preferably of 30 to 50 wt. %, based on the total weight of the first particle and the second particle.

According to an embodiment, in step a. of the process the first particle and the second particle are provided in a weight fraction of second particle of 30 to 90 wt. %, preferably of 40 to 80 wt. %, more preferably of 50 to 70 wt. %, based on the total weight of the first particle and second particle.

According to an embodiment, nutraceuticals, vitamins, minerals and/or microcapsules as described herein-above can be added to the particles in step a. and/or b.

According to one embodiment, the amount of liquid to be added in step c. is 0.1 to 10 wt. %, preferably 0.2 to 5 wt. %, preferably 0.3 to 3 wt. %, more preferably 0.4 to 2 wt. %, even more preferably 0.5 to 1 wt. %, based on the total weight of the wet mixture.

According to an embodiment, the liquid to be added in step c. is added at a rate of 50 to 150 grams per hour, preferably at a rate of 70 to 130 grams per hour, more preferably at a rate of 90 to 110 grams per hour.

According to one embodiment, the liquid to be added in step c. is water.

According to another embodiment, the liquid to be added in step c. is an aqueous solution suitable for human consumption, preferably an aqueous solution of carbohydrates. The carbohydrate may be selected from the group of glucose, fructose, mannose, galactose, arabinose, fucose, sorbitol, mannitol or mixtures thereof, preferably the carbohydrate may be glucose or fructose.

According to a preferred embodiment, the aqueous solution of carbohydrates may be a saturated solution.

According to an embodiment, the liquid to be added in step c. contains a compound suitable for coating the single first and single second particles. According to a preferred embodiment, the liquid is an aqueous solution of least one compound chosen in the group consisting of inulin, chicory root fiber, vegetables/fruit/tuber fibers, sucrose, glucose, lactose, levulose, fructose, maltose, ribose, dextrose, isomalt, sorbitol, mannitol, xylitol, lactitol, maltitol, erythritol, pentatol, arabinose, pentose, xylose, galactose, hydrogenated starch hydrolysates, maltodextrin, agar, carrageenan, other gums, corn syrup polydextrose, synthetic polymers such as polyvinyl alcohol, semi-synthetic polymers such as succinylated starch, cellulose ethers, proteins such as gelatin, and derivatives and mixtures thereof.

According to an embodiment, the process is conducted using an extruder, preferably using an extruder with 8 barrels and conveying screw elements. According to a preferred embodiment, the extruder is a twin-screw extruder.

According to another embodiment, the process is conducted using a food processor or food mixer, such as an industrial food processor or industrial food mixer, respectively, a dual asymmetric centrifuge (DAC) mixer or a rotary mixer/dryer, such as an industrial rotary mixer/dryer

According to an embodiment, the extruder is run at a speed of 50 to 500 rpm, preferably of 100 to 300 rpm, more preferably of 150 to 250 rpm, even more preferably of 175 to 225 rpm.

According to an embodiment, no additional heat is added in the process.

According to an embodiment, the wet granulation process has a process temperature between 5 to 80° C., preferably between 10 to 60° C., more preferably between 20 to 40° C.

According to an embodiment, the process further comprises an additional drying step e.

According to a preferred embodiment, the drying step e. removes the liquid, preferably water, that was added during wet granulation in step c. The amount of liquid, preferably water to be removed is from 0.01 to 100 wt. %, preferably 20-100%, more preferably 40-100 wt. %, even more preferably 60 to 100 wt. %, and most preferably 80 to 100 wt. %, based on the total weight of the added liquid, preferably added water.

According to an alternative embodiment, the agglomerates according to the present invention can be prepared by the following process:
a. Preparing a first or second particle according to the process described herein-above;
b. Adding a second or first particle as described hereinabove to the first or second particle of step a. during the final step of preparation in which the first or second particle comprise enough moisture so that the second or first particle can stick to thereto.
c. Collecting the agglomerated particles,
d. Optionally, drying the agglomerated particles.
   The moisture content in step b. can be either due to the preparation process of the first or second particles or can be adjusted at the end of the preparation process of the first or second particles.
   The moisture content should be high enough to make the second or first particles, respectively, stick to the first or second particle.
   In a preferred embodiment, the moisture on the surface should be so that the surface of the particle has a T_{g} below room temperature (below 20° C.) and at the core of the particles of above room temperature (more than 20° C.).
   In a preferred embodiment, the surface of the particles has a T_{g}<20° C., preferably a T_{g}<0° C. and a T_{g}<−20° C. In a preferred embodiment, the core has a T_{g}>20° C., preferably a T_{g}>30° C. and even more preferably a T_{g}>40° C.
   The T_{g} of the surface and core can be measured by Differential Scanning calorimetry.

### Process for Preparing the Flavored Delivery System

The flavored delivery system can be prepared simply by blending the first particle and the second particle.

### Consumer Product Comprising the Flavored Delivery System

A second object of the present invention is a flavored consumer product comprising the flavored particles delivery system. Preferably, the flavoured product is a food product or a beverage.

When the food product is a particulate or powdery food, the dry particles may easily be added thereto by dry-mixing. Typical food products are selected from the group consisting of an instant soup or sauce, a breakfast cereal, a powdered milk, a baby food, a powdered drink, a powdered chocolate drink, a spread, a powdered cereal drink, a chewing gum, an effervescent tablet, a cereal bar, and a chocolate bar. The powdered foods or drinks may be intended to be consumed after reconstitution of the product with water, milk and/or a juice, or another aqueous liquid.

The dry particles provided herein may be suitable for conveying flavors to beverages, fluid dairy products, condiments, baked goods, frostings, bakery fillings, candy, chewing gum and other food products.

Beverages include, without limitation, carbonated soft drinks, including cola, lemon-lime, root beer, heavy citrus (“dew type”), fruit flavored and cream sodas; powdered drinks, as well as liquid concentrates such as fountain syrups and cordials; hot beverages including malt drinks, cocoa, coffee and coffee-based drinks, coffee substitutes and cereal-based beverages; teas, including dry mix products as well as ready-to-drink teas (herbal and tealeaf based); fruit and vegetable juices and juice flavored beverages as well as juice drinks, nectars, concentrates, punches and “ades”; sweetened and flavored waters, both carbonated and still; sport/energy/health drinks; alcoholic beverages plus alcohol-free and other low-alcohol products including beer and malt beverages, cider, and wines (still, sparkling, fortified wines and wine coolers); other beverages processed with heating (infusions, pasteurization, ultra-high temperature, ohmic heating or commercial aseptic sterilization) and hot-filled packaging; and cold-filled products made through filtration or other preservation techniques.

According to a particular embodiment, the flavored consumer product is in the form of a tea drink.

According to a particular embodiment, the flavored consumer product is in the form of a coffee drink.

Fluid dairy products include, without limitation, non-frozen, partially frozen and frozen fluid dairy products such as, for example, milks, ice creams, sorbets and yogurts.

Condiments include, without limitation, ketchup, mayonnaise, salad dressing, Worcestershire sauce, fruit-flavored sauce, chocolate sauce, tomato sauce, chili sauce, and mustard.

Baked goods include, without limitation, cakes, cookies, pastries, breads, donuts and the like.

Bakery fillings include, without limitation, low or neutral pH fillings, high, medium or low solids fillings, fruit or milk based (pudding type or mousse type) fillings, hot or cold make-up fillings and nonfat to full-fat fillings.

As non-limiting examples, the flavored consumer product is in the form of a
Baked goods (e.g. bread, dry biscuits, cakes, other baked goods),
Non-alcoholic beverages (e.g. carbonated soft drinks, bottled waters, sports/energy drinks, juice drinks, vegetable juices, vegetable juice preparations),
Alcoholic beverages (e.g. beer and malt beverages, spirituous beverages),
Instant beverages (e.g. hot drinks, instant vegetable drinks, powdered soft drinks, instant coffee and tea, chocolate drinks, malt drinks),
Cereal products (e.g. breakfast cereals, pre-cooked ready-made rice products, rice flour products, millet and sorghum products, raw or pre-cooked noodles and pasta products),
Milk products (e.g. fresh cheese, soft cheese, hard cheese, milk drinks, whey, butter, partially or wholly hydrolysed milk protein-containing products, fermented milk products, condensed milk and analogues),
Dairy based products (e.g. fruit or flavored yoghurt, ice cream, fruit ices)
Confectionary products (e.g. chewing gum, hard and soft candy)
Chocolate and compound coatings
Products based on fat and oil or emulsions thereof (e.g. mayonnaise, spreads, margarines, shortenings, remoulade, dressings, spice preparations),
Spiced, marinated or processed fish products (e.g. fish sausage, surimi),
Eggs or egg products (dried egg, egg white, egg yolk, custard),
Desserts (e.g. gelatins and puddings)
Products made of soya protein or other soya bean fractions (e.g. soya milk and products made therefrom, soya lecithin-containing preparations, fermented products such as tofu or tempeh or products manufactured therefrom, soya sauces),
Vegetable preparations (e.g. ketchup, sauces, processed and reconstituted vegetables, dried vegetables, deep frozen vegetables, pre-cooked vegetables, vegetables pickled in vinegar, vegetable concentrates or pastes, cooked vegetables, potato preparations),
Vegetarian meat replacer, vegetarian burger
Spices or spice preparations (e.g. mustard preparations, horseradish preparations), spice mixtures and, in particular seasonings which are used, for example, in the field of snacks.
Snack articles (e.g. baked or fried potato crisps or potato dough products, bread dough products, extrudates based on maize, rice or ground nuts),
Meat products (e.g. processed meat, poultry, beef, pork, ham, fresh sausage or raw meat preparations, spiced or marinated fresh meat or cured meat products, reformed meat),
Ready dishes (e.g. instant noodles, rice, pasta, pizza, tortillas, wraps) and soups and broths (e.g. stock, savory cube, dried soups, instant soups, pre-cooked soups, retorted soups), sauces (instant sauces, dried sauces, ready-made sauces, gravies, sweet sauces).

The invention will now be described in further detail by way of the following examples.

### EXAMPLE 1

### Preparation of the Delivery System According to the Invention

### 1-A/Preparation of Particles A

### Description of the Process

A BC-21 co-rotating twin screw extruder (Clextral, Firminy France, L/D=32) was used to encapsulate a flavor oil into a solid particulate form. The powder feed consisted of maltodextrin 18DE, modified starch (Capsule, and a blue dye. The powder was fed into the extruder by means of a loss-in-weight powder feeder with a set point of 8.0 kg/hr. A lubricant (Neobee M5) was injected at a rate of 100 g/hr. Temperature set points on the extruder barrels ranged from 20-100° C. The screw speed kept constant at 500 rpm. The carbohydrate melt was extruded through a die plate with 1-mm diameter holes. After establishing steady-state extrusion condition, particles were cut by means of rotating cutting blades/knives and particles were sieved between 710 and 1,400 μm.

Flavor oil A (see composition in Table 2) was injected into the extruder. Water was injected at 450 g/hr as a plasticizer into the extruder to obtain samples with glass transition temperature of (T_{g}) about 35-40° C.

Particles having the following composition were obtained.

TABLE 1
Particles A composition

| | Amount |
|---|---|
| Carrier | 89% |
| Flavor oil (see Table 2) | 11% |
| | 100% |

### 1-B/Preparation of Particles A1

Particles A1 were prepared using the same protocol as for preparing particles A except that 43% of the injected plasticizer has been replaced from water to propylene glycol.

TABLE 2
Flavor oil A composition

| Raw materials | Amount |
|---|---|
| ACETIC ACID | 3.01 |
| ISOPROPYLIC ALCOHOL | 12.52 |
| 2-METHYLBUTANAL | 31.31 |
| ETHYL ACRYLATE | 4.83 |
| METHYL TETRAHYDROFURANONE | 33.31 |
| 2-FURANMETHANETHIOL | 4.51 |
| FURFURYL METHYL SULFIDE | 10.52 |
| | 100% |

### 2-A/Preparation of Particles B

### Description of the Process:

A syrup solution of the following composition:

| Ingredients | Parts by weight |
|---|---|
| Sucrose | 40 |
| Maltodextrin 18DE | 40 |
| Water | 20 |

was pumped at 80° into the first heat exchanger, at a rate of 8.0 kg/min.

Steam (approximately at 150°) was supplied to the jacket of a heat exchanger to evaporate water from the syrup. Steam temperature and flow rate were regulated to give the desired moisture content after evaporation. Residence time in the heat exchanger was of 2 min.

The concentrated syrup plus water exited the heat exchanger into a tank were the water vapor was removed. The melt was there about 6% moisture content and 127° C.

A pump removed the melt from the tank and a flavor oil B (see composition in Table 4) was injected into the processing line at a rate of 1.5 kg/min.

The mixture of melt and flavor oil passed for 10 s through an in-line high shear mixer to form an emulsion.

The emulsion passed through the second heat exchanger to cool to a temperature of 120° as measured at the exit of the heat exchanger. The temperature of the media (hot water) flowing through the jacket of the heat exchanger was regulated to achieve the exit temperature of the emulsion. The product then passed through the extrusion die, into a cold isopropanol bath. After impact breaking, of the filaments, the particles there-obtained were dried in a fluid bed dryer with a residence time of 45 min.

Particles having the following composition were obtained.

TABLE 3
Particles B composition

| | Amount |
|---|---|
| Carrier | 95% |
| Flavor oil (see Table 4) | 5% |
| | 100% |

### 2-B/Preparation of Particles B1-B4

Particles B1 to B4 were prepared using the same protocol as for preparing particles B using the following carrier compositions.

| | B1 | B2 | B3 | B4 |
|---|---|---|---|---|
| Maltodextrin 18DE | 70 | 18 | 20 | 22 |
| Maltodextrin 5DE | 0 | 52 | 60 | 68 |
| Mn carrier (g/mol) | 643 | 793 | 977 | 1270 |
| Sucrose | 30 | 30 | 20 | 10 |

TABLE 4
Flavor oil B composition

| Raw materials | Amount |
|---|---|
| BUTYRIC ACID | 0.20 |
| VANILLIN | 3.55 |
| COFFEE EXTRACTS/POWDERS | 85.00 |
| 3-HYDROXY-2-METHYL-4H-PYRAN-4-ONE | 0.10 |
| DELTA DECALACTONE | 1.00 |
| 2-METHOXY-4-VINYLPHENOL | 10.00 |
| 2,6-DIMETHYLPYRAZINE | 0.15 |
| | 100% |

### 3/Preparation of the Blend

Particles A and particles B were mixed at a ratio of 20:80 to obtain the delivery system of the present invention.

### EXAMPLE 2

### Performance of the Delivery System of the Invention in a Hot Coffee Drink

Panelists were asked to describe the sensory profile by using various standardized sensory descriptors in a hot coffee drink comprising:
1/only particles A
2/only particles B
3/delivery system of the present invention (A+B)

Results are summarized in the Table below.

TABLE 5
Sensory results

| | | Delivery system according |
|---|---|---|
| Particle A | Particle B | to the invention |
| Roasted, burnt, buttery | Roasted, creamy | Green, ashy |

Similar results are obtained when mixing particle A or A1 with anyone of particles B, B1 to B4.

One can conclude from this Table, that the delivery system of the present invention provides a new sensory profile compared to the particle A or particle B taken separately.

### EXAMPLE 3

### Delivery System According to the Invention in a Hot Tea Drink

Particles C encapsulated a flavor oil C were prepared according to the process for preparing Particles A (same carrier as particle A). Particles D encapsulated a flavor oil D were prepared according to the process for preparing Particles B (same carrier as particle B).

Particles C and particles D are mixed at a ratio of 20:80 to obtain the delivery system of the present invention and incorporated in a hot tea drink.

### EXAMPLE 4

### Wet Granulation Process for the Preparation of Agglomerated Particles A and B

### Description of the Process

Particles A (Particle A as described herein above with an orange type flavor) and B (Particle B as described herein above with a Bergamot type flavor) were blended together resulting in a uniform mixture. This mixture was loaded into a loss-in-weight feeder and the feeder was run to catch five samples ensuring that the entire stream of product falling for several seconds was caught. This unprocessed mixture served as an unagglomerated control. A twin screw extruder (Leistritz ZSE 18) with 8 barrels and only conveying screw elements was used to agglomerate the remaining uniform mixture of particles A and B. The extruder was run at 200 rpm with all barrels set to a temperature of 25° C. Water was injected in barrel 3 and no die plate was used. A pressure sensor was installed on the last barrel. Water was injected at a rate of 100 gram water per hour, resulting in an added moisture content of 4.8%. The moisture content was successively changed to 2.9%, 1.0% and 2.0% while at each step the extruder was given time to equilibrate. At each moisture level, five product samples were taken.

The properties of the obtained agglomerated particles A and B are summarized in the table below.

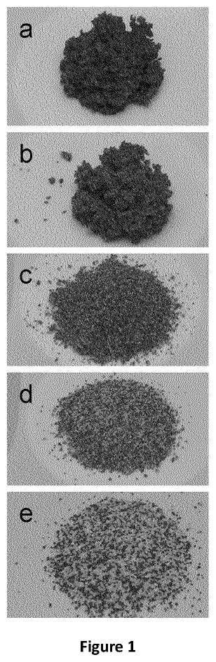

TABLE 6
Properties of the agglomerated particles A and B

| | | | Reference |
|---|---|---|---|
| Moisture content | Observation | Uniformity | to FIG. 1 |
| 4.8% | Sticky mixture. | Very uniform, | A |
| | | homogeneous | |
| | | mixture. | |
| 2.9% | Less sticky | Uniform, some | B |
| | mixture. | particles A and B | |
| | | visible. | |
| 2.0% | Free flowing | Uniform, particles | C |
| | agglomerates. | A and B visible. | |
| 1.0% | Dry free flowing | More uniform than | D |
| | agglomerates. | control, particles A | |
| | | and B visible. | |
| Control | Dry free flowing | Random, pockets | E |
| (untreated) | particles. | of particles A and B | |

The wet granulation process resulted in agglomerates of particles A and B. A moisture content of 1% and 2% gave the best results in the form of free-flowing agglomerates. FIG. 1 shows that all agglomerates of particles A and B prepared by the wet granulation process (FIG. 1, a to d) are significantly more uniform compared to the non-agglomerated control (FIG. 1, e).

### EXAMPLE 5

### Wet Granulation Process for the Preparation of Agglomerated Particles A and B

Following the process of Example 4, the following modifications are made:

TABLE 7
Formula of Example 5

| Ingredient | Weight (g) |
|---|---|
| Particles A and B (wt. ratio 20:80) | 1000.1 |
| Orange Powder (microcapsules | 500.07 |
| prepared according to WO 2017/134179 | |
| with an orange flavor) | |
| Mineral (Sodium Chloride) | 20.22 |

DI Water used as Liquid

The extruder was run with all barrels set to a temperature of 20° C.

During this trial, 3 samples were collected under the following conditions:

TABLE 8
Sample collection conditions

| Sample | Sample 5.1: | Sample 5.2: | Sample 5.3: |
|---|---|---|---|
| Screw Speed (rpm) | 200 | 200 | 200 |
| Injection Rate (ml/min) | 2 | 1.5 | 2.5 |
| Feed Rate (kg/h) | 2.0 | 2.0 | 2.0 |
| Torque reading (%) | 2 | 3 | 4 |
| Die Pressure (Bar) | 0 | 0.01 | 0.01 |

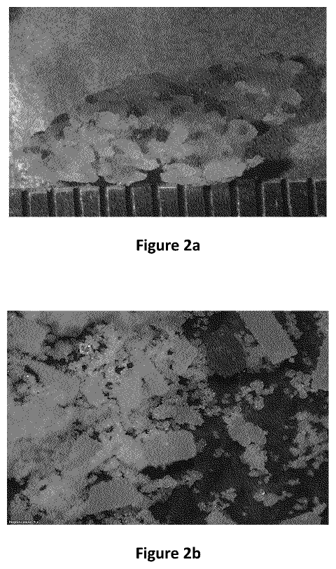

All samples showed agglomeration of particles A and B. Sample 5.1 yielded good size agglomerated particles, about 5 mm in size with a moisture content of 12.0%. Similar results were observed with sample 5.2, the particles formed were about 4 mm in size and a moisture content of 10.5%. Considering the results from sample 5.1 and 5.2, the water pump setting was changed to a higher speed in sample 5.3. The product obtained was nicely agglomerated and consistent with larger particle size compared to samples 5.1 and 5.2. Moisture content of the sample was recorded to be 13.0% and the agglomerated particles were around 10 mm in size (cf. FIG. 2a) and showed agglomeration compared to unagglomerated particle mixture prior to the inventive process (cf. FIG. 2b).

### EXAMPLE 6

### Wet Granulation Process for the Preparation of Agglomerated Particles A and B

Following the process of Example 5, the following modifications are made:

TABLE 9
Formula of Example 6

| Ingredient | Weight (g) |
|---|---|
| Particles A and B (wt. | 1000.1 |
| ratio 20:80) | |
| Spray Dry Powder | 500.01 |
| Citric Acid | 20.06 |

DI Water used as Liquid

During this trial 2 separate samples were collected under the following conditions:

TABLE 10
Samples collection conditions

| Sample | Sample 6.1: | Sample 6.2: |
|---|---|---|
| Screw Speed (rpm) | 150 | 150 |
| Injection Rate (ml/min | 1 | 0.75 |
| Feed Rate (kg/h) | 1.5 | 1.5 |
| Torque reading (%) | 22 | 31 |
| Die Pressure (Bar) | 0.04 | 0.04 |

Sample 6.1 contained 8.4% moisture and contained particles around 3 mm in size and smaller. Sample 6.2 collected contained 7.6% moisture and the size of the agglomerated particles appeared smaller than sample 6.1.

### EXAMPLE 7

### Wet Granulation Process for the Preparation of Agglomerated Particles A and B

Following the process of Example 5, the following modifications are made:

TABLE 11
Formula of Example 7

| Ingredient | Weight (g) |
|---|---|
| Particles A and B (wt. | 1000.1 |
| ratio 20:80) | |
| Spray Dry Powder | 500.01 |
| Vitamin (Ascorbic acid) | 20.06 |

DI Water used as Liquid

During this trial, the sample was collected under the following condition:

TABLE 12
Sample Collection Condition

| Sample | Sample 7.1: |
|---|---|
| Screw Speed (rpm) | 150 |
| Injection Rate (ml/min | 2.25 |
| Feed Rate (kg/h) | 1.5 |
| Torque reading (%) | 15 |
| Die Pressure (Bar) | 0.05 |

Example 7 was a blend of two different flavor systems with two different flavor oils, spray dried powder and a vitamin (Table 11). Sample 7.1 was nicely agglomerated with a size of about 4 mm and with a moisture content of 10.2%.

### EXAMPLE 8

### Wet Granulation Process for the Preparation of Agglomerated Particles A and B

Following the process of Example 5, the following modifications are made:

Modified particles A and B are used in that no coloring dye was included to result in off-white particles A and B.

TABLE 13
Formula of Example 8

| Ingredient | Weight (g) |
|---|---|
| Off-white Particles B | 1150.0 |
| (Particle B as described | |
| hereinabove with an | |
| orange flavor) | |
| Off-white Particles A | 350.03 |
| Particle A as described | |
| hereinabove with a | |
| cinnamon flavor) | |

Corn syrup solid used as liquid

During this trial, the samples were collected under the following conditions:

TABLE 14
Samples Collection Conditions

| Sample | Sample 8.1: | Sample 8.2: |
|---|---|---|
| Screw Speed (rpm) | 200 | 200 |
| Injection Rate (ml/min | 1 | 1 |
| Feed Rate (kg/h) | 2.0 | 2.5 |
| Torque reading (%) | 3 | 3 |
| Die Pressure (Bar) | 0.06 | 0.05 |

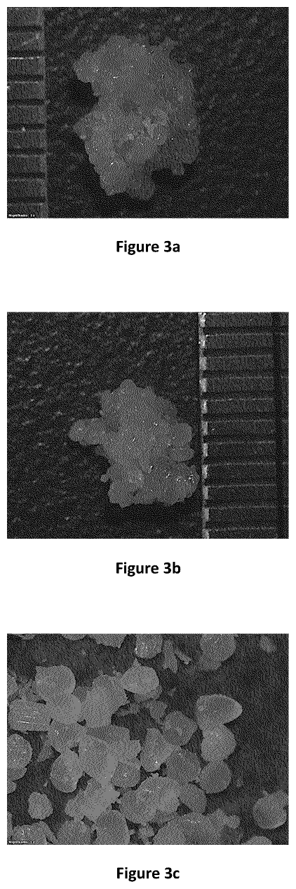

The liquid binder injected for wet granulation was a 5% w/w corn solid syrup solution. Two samples were collected during the trial, sample 8.1 contained 10.5% moisture and the agglomerated particles obtained were about 7 mm in size (cf. FIG. 3a) compared to the sample 8.2 which had 9.4% moisture content and the particles obtained were about 6 mm in size (cf. FIG. 3b) and compared to a corresponding unagglomerated particle mixture prior to the inventive process (cf. FIG. 3c). An optional drying step under mild conditions may be used to further lower the moisture content.

### EXAMPLE 9-15

### Wet Granulation by a Dual Asymmetric Centrifuge (DAC) Mixer

A FlackTek Speedmixer® (DAC 600.1 FVZ LR) was used as an example of a Dual Asymmetric Centrifuge (DAC) mixer. All the ingredients were weighed in a mixing cup and spun at different speeds for varying time.

Samples mixed in DAC mixer formed small, agglomerated particles.

TABLE 15-21
Attributes of Examples 9-15

| Example 9 | | |
|---|---|---|
| Example 5 mixture in grams (Table 7) | 23.74 | |
| Deionized water in grams | 1.26 | |
| Mixing Speed, rpm | 2000 | 2000 |
| Mixing Time, sec | 25 | 25 |
| Example 10 | | |
| Example 5 mixture in grams (Table 7) | 23.74 | |
| Deionized water in grams | 1.26 | |
| Mixing Speed, rpm | 1800 | 1500 |
| Mixing Time, sec | 60 | 60 |
| Example 11 | | |

| Example 6 mixture in grams (Table 9) | 23.74 | | |
|---|---|---|---|
| 2% w/w maltodextrin + water in grams | 1.26 | | |
| Mixing Speed, rpm | 1800 | 2000 | 1000 |
| Mixing Time, sec | 30 | 60 | 60 |

| | |
|---|---|
| Example 12 | |
| Example 8 mixture in grams (Table 13) | 22.5 |
| 10% w/w corn syrup solid + water in grams | 2.5 |
| Mixing Speed, rpm | 1500 |
| Mixing Time, sec | 60 |
| Example 13 | |
| Example 8 mixture in grams (Table 13) | 23.74 |
| 10% w/w corn syrup solid + water in grams | 1.26 |
| Mixing Speed, rpm | 1500 |
| Mixing Time, sec | 60 |
| Example 14 | |
| Example 8 mixture, gm (Table 13) | 24.5 |
| 10% w/w corn syrup solid + water in grams | 0.5 |
| Mixing Speed, rpm | 1500 |
| Mixing Time, sec | 60 |
| Example 15 | |
| Example 7 mixture in grams (Table 11) | 24.5 |
| 10% w/w corn syrup solid + water in grams | 1.28 |
| Mixing Speed, rpm | 1500 |
| Mixing Time, sec | 60 |

### EXAMPLE 16

### Wet Granulation Process for the Preparation of Agglomerated Particles A and B

TABLE 22
Formula for Example 16

| Ingredient | Weight (g) |
|---|---|
| Particle A (Bergamot) | 99.92 |
| Particle B (Citrus) | 100.8 |
| Erythritol | 700.57 |
| Citric Acid | 100.82 |
| Vitamin C (Ascorbic Acid) | 99.92 |
| Orange Spray Dry Powder | 250.86 |

DI Water for injection

During this trial, 4 samples were collected under the following conditions:

TABLE 23
Samples collection conditions

| | Sample | Sample | Sample | Sample |
|---|---|---|---|---|
| Sample | 16.1: | 16.2: | 16.3: | 16.4: |
| Screw Speed (rpm) | 200 | 200 | 200 | 200 |
| Injection Rate (ml/min) | 1.4 | 1.0 | 0.7 | 1.0 |
| Feed Rate (kg/h) | 2.0 | 2.0 | 2.0 | 2.0 |
| Torque reading (%) | 3 | 8 | 11 | 14 |
| Die Pressure (Bar) | 0 | 0 | 0 | 0 |

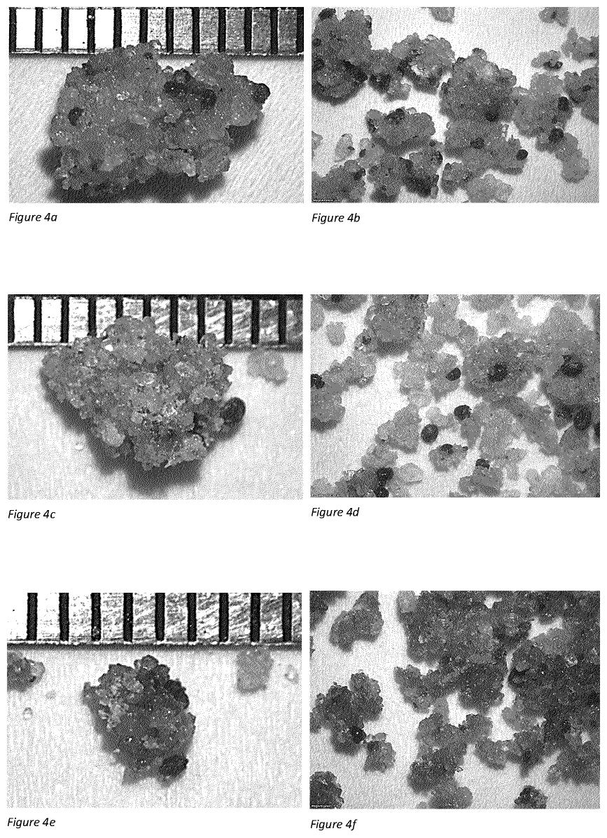

Sample 16.1 yielded decent size agglomerated particles, about 9 mm in size (FIGS. 4a and 4b). Moisture content was 6.4%. The agglomerated product collected was a little wet and the particles adhered to each other in the container but with little extra drying, product obtained was non-sticky and well agglomerated. 16.2 also yielded decent size agglomerated particles, about 9 mm in size along few smaller clusters (FIGS. 4c and 4d). The moisture content measured was 4.5%. 16.3 depicts similar behavior like 16.2 with the only difference that the agglomerates formed are smaller than 16.2, about 5 mm in size (FIGS. 4e and 4f). Sample 16.4 was very similar to 16.2 where decent size agglomerates were formed along with other small, agglomerated particles.

1. A flavored particles delivery system comprising:
at least a first particle comprising a first carrier and a first flavor oil entrapped within said first carrier; and
at least a second particle comprising a second carrier and a second flavor oil entrapped within said second carrier,
wherein the first flavor oil and the second flavor oil are different and/or the first carrier and the second carrier are different, and
wherein at least one first particle is agglomerated with at least one second particle.

2. The flavored particles delivery system according to claim 1, wherein the first flavor oil and the second flavor oil are different and the first carrier and the second carrier are different.

3. The flavored particles delivery system according to claim 1, wherein the first carrier has a molecular weight Mn between 1250 and 5000 g/mol and/or wherein the second carrier has a molecular weight Mn between 600 and 2000 g/mol.

4. The flavored particles delivery system according to claim 1, wherein the first flavor oil comprises heat susceptible flavoring ingredients and wherein the second flavor oil comprises oxidation susceptible flavoring ingredients.

5. The flavored particles delivery system according to claim 1, wherein the first flavor oil comprises flavoring ingredients selected from the group consisting of acid, alcohol, aldehyde, ester, furan, furanone-ketone, ketone and mixtures thereof and/or wherein the second flavor oil comprises flavoring ingredients selected from the group consisting of acid, alcohol, aldehyde, ketone, lactone, phenol, pyrazine and mixtures thereof.

6. The flavored particles delivery system according to claim 1, wherein:
the first flavor oil comprises at least 10% of flavoring ingredients having a molecular weight less than 100 Dalton and/or a vapor pressure higher than 10 mmHg and/or a boiling point less than 100° C., and/or
the second flavor oil comprises at least 25% of flavoring ingredients having a molecular weight greater than 100 Dalton and/or a vapor pressure less than 10 mm Hg and/or a boiling point higher than 100° C.

7. The flavored particles delivery system according to claim 1, wherein the first carrier and/or the second carrier comprises at least one compound selected from the group consisting of inulin, chicory root fiber, vegetables/fruit/tuber fibers, sucrose, glucose, lactose, levulose, fructose, maltose, ribose, dextrose, isomalt, sorbitol, mannitol, xylitol, lactitol, maltitol, erythritol, pentatol, arabinose, pentose, xylose, galactose, hydrogenated starch hydrolysates, maltodextrin, agar, carrageenan, other gums, polydextrose, synthetic polymers, polyvinyl alcohol, semi-synthetic polymers, succinylated starch, cellulose ethers, proteins, gelatin, and derivatives and mixtures thereof.

8. The flavored particles delivery system according to claim 1, wherein the weight ratio between the first particle and the second particle is comprised between 10:90 and 90:10.

9. The flavored particles delivery system according to claim 1, wherein the first particle and the second particle are obtained by different processes.

10. A process of preparing a flavored particles delivery system, the process comprises the steps of:
a. providing at least a first particle and at least a second particle;
b. mixing the first particle and the second particle to form a mixture;
c. bringing the mixture in contact with a liquid to form a wet mixture, wherein the amount of liquid is suitable for wet granulation; and
d. conducting wet granulation of the wet mixture.

11. The process according to claim 10, wherein the amount of liquid to be added in step c. is not more than 10 wt. %, based on the total weight of the wet mixture.

12. The process according to claim 10, wherein wet granulation is conducted using an extruder.

13. The process according to claim 10, further conducting a step of drying after the step of conducting wet granulation.

14. A flavored consumer product comprising the flavored particles delivery system according to claim 1.

15. The consumer product according to claim 14, wherein the consumer product is selected from the group consisting of a beverage, a sweet good, and a savory good.

16. The flavored particles delivery system according claim 1, wherein the weight ratio between the first particle and the second particle is comprised between 20:80 and 80:20.

17. The flavored particles delivery system according claim 1, wherein the first particle is obtained by twin-screw extrusion and wherein the second particle is obtained by hot melt extrusion.

18. The process according to claim 10, wherein the liquid is water.

19. The process according to claim 10, wherein the amount of liquid to be added in step c. is not more than 5 wt. %, based on the total weight of the wet mixture.

20. The process according to claim 10, wherein wet granulation is conducted using an extruder with 8 barrels and conveying screw elements.
